(19) United States
(12) Patent Application Publication
(10) Pub. No.: US 2019/0235657 A1
(43) Pub. Date: Aug. 1, 2019

(54) CAPACITIVE SENSOR FOR STYLUS

(71) Applicant: Microsoft Technology Licensing, LLC, Redmond, WA (US)

(72) Inventor: Amit SCHWITZER, Hertzeliya (IL)

(21) Appl. No.: 15/882,994

(22) Filed: Jan. 29, 2018

(51) Int. Cl. G06F 3/044; G06F 3/0354; G06F 3/041

(52) U.S. Cl. CPC G06F 3/044; G06F 3/0414; G06F 3/03545

(57) ABSTRACT

A capacitive sensor for use in a stylus comprises a body of deformable conductive material with a first end and a second end, the first end being configured for fixing to a distal end of a shaft on a longitudinal axis of the stylus and having a stylus tip at a tip end of the shaft. The second end of the body has a face configured to abut a sensing region of a printed circuit board of the stylus when the capacitive sensor is in an active state. A support structure extends from the body of flexible conductive material beyond the second end of the body and is configured to fix to the printed circuit board such that the face of the second end of the body is separated from the sensing region by an air gap when the capacitive sensor is at rest.

### BACKGROUND

The technology generally relates to capacitive sensors for use in digital styli such as for detecting pressure exerted on a tip of the digital stylus.

Accuracy of capacitance measurements affects the quality of control of applications using the digital stylus, such as the quality of control of a graphical user interface where the digital stylus is used with a digitizer panel of a touch screen such as in a tablet computer or other touch screen computing device.

Manufacture of digital styli is complex and expensive as there are many components to be assembled and the construction is typically complex in order to make best use of the limited space available within a stylus.

The embodiments described below are not limited to implementations which solve any or all of the disadvantages of known capacitive sensors and/or digital styli.

### SUMMARY

The following presents a simplified summary of the disclosure in order to provide a basic understanding to the reader. This summary is not intended to identify key features or essential features of the claimed subject matter nor is it intended to be used to limit the scope of the claimed subject matter. Its sole purpose is to present a selection of concepts disclosed herein in a simplified form as a prelude to the more detailed description that is presented later.

In various examples a capacitive sensor for use in a stylus is described. The capacitive sensor comprises a body of deformable conductive material with a first end and a second end, the first end being configured for fixing to a distal end of a shaft on a longitudinal axis of the stylus and having a stylus tip at a tip end of the shaft. The second end of the body has a face configured to abut a sensing region of a printed circuit board of the stylus when the capacitive sensor is in an active state. A support structure extends from the body of flexible conductive material beyond the second end of the body and is configured to fix to the printed circuit board such that the face of the second end of the body is separated from the sensing region by an air gap when the capacitive sensor is in a rest state.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1A is a perspective view of a stylus;

FIG. 1B is a cross section through part of the stylus of FIG. 1A and omitting a housing of the stylus;

FIG. 2 is a schematic diagram of a computing device with a digitizer panel, and also showing a stylus;

FIG. 3 is a schematic diagram of a digitizer, control module and host device

FIG. 4A shows a capacitive sensor;

FIG. 4B shows the capacitive sensor of FIG. 4A fixed to the distal end of a stylus tip shaft and with a support structure of the capacitive sensor fixed to a printed circuit board;

FIG. 5A is a cross section through part of another stylus and showing the capacitive sensor;

FIG. 5B is a cross section through part of another stylus and showing the capacitive sensor;

FIG. 6 is a schematic diagram of a shim used during manufacturing of a stylus;

FIG. 7 is a flow diagram of a method of manufacture of a stylus.

Like reference numerals are used to designate like parts in the accompanying drawings.

### DETAILED DESCRIPTION

The detailed description provided below in connection with the appended drawings is intended as a description of the present examples and is not intended to represent the only forms in which the present example are constructed or utilized. The description sets forth the functions of the example and the sequence of operations for constructing and operating the example. However, the same or equivalent functions and sequences may be accomplished by different examples.

As mentioned above, accuracy of capacitance measurements is very important in styli used with touch panel sensors such as in touch screen computing devices. Where the capacitance sensor is of the type which uses an air gap between a conductive body and a conductive trace or a micro-electro-mechanical (MEMS) pressure sensor, the existing manufacturing process is complex and typically involves a calibration process to calibrate the capacitance sensor. Multiple different parts are assembled together to form the capacitance sensor and the relative position of the parts has to be controlled carefully to create the suitable air gap. The size of the air gap typically varies slightly between styli of the same design due to differences introduced during the manufacturing process and this introduces inter-stylus variation in the capacitance sensors once installed in the styli. To allow for this variation the capacitance sensor has to be calibrated while in the manufacturing plant to enable obtaining capacitance measurements that are accurate. Manufacture of the stylus is thus relatively complex and error prone leading to defective styli that have to be discarded, or to styli that are likely to malfunction. There is a resulting increase in manufacturing costs.

In various examples described herein, there is a design of a capacitance sensor that is simple to manufacture and that avoids the need for calibration of the capacitance sensor after installation in a stylus.

Electronic devices such as tablet computers, smart phones, smart watches and others often incorporate a touch panel to display information and to receive one or more user inputs made by touching the display. The touch panel may be a mutual capacitance touch panel with a capacitive sensing medium referred to as a digitizer device incorporating a plurality of row electrodes (referred to as transmit electrodes) and a plurality of column electrodes (referred to as receive electrodes) arranged in a rectangular grid pattern. A drive signal voltage is applied on the transmit electrodes and a voltage is measured at each receive electrode. Since the human body is an electrical conductor, when a finger touches or comes close to the touch panel, an electrostatic field of the touch panel is distorted, which produces a measurable change at the receive electrodes. The terms “electrode”, “antenna” and “transmitter” have the same meaning herein.

Coordinates of the user input at the touch panel are computed from the measured change and interpolation may be used to compute coordinates of user input positions within individual cells of the grid rather than at intersections of the grid.

Where a stylus 100 or pen is used in conjunction with the touch panel, the stylus or pen incorporates one or more drive electrodes (referred to herein as transmitters) so that drive electrodes at the touch panel itself may be used as receive electrodes. The present technology is concerned with a capacitive sensor for use inside such a stylus 100.

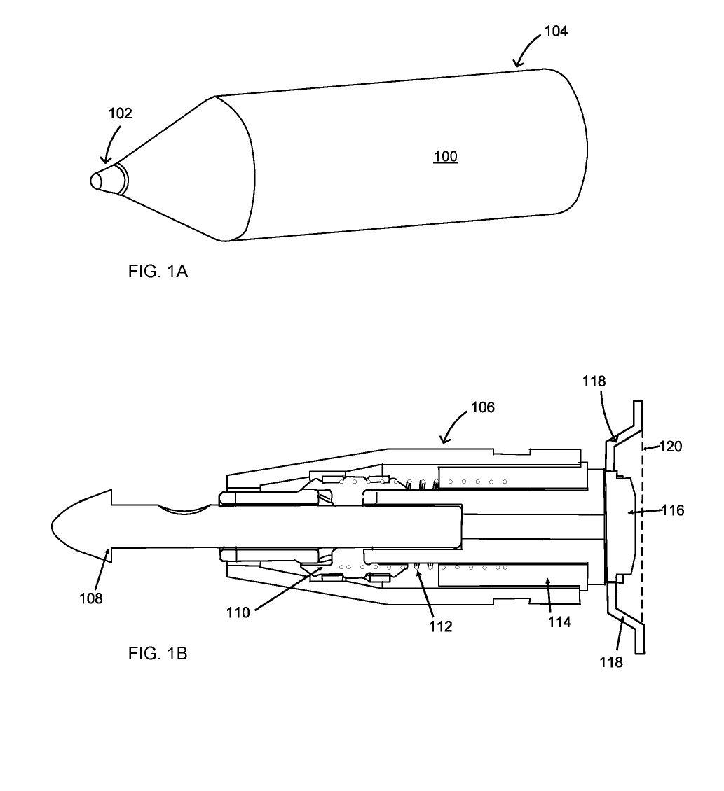

FIG. 1A is a perspective view of a stylus 100 with a tip 102 end and a distal end 104. The stylus incorporates a plurality of components which are not visible in FIG. 1A, such as one or more transmitters, one or more pressure sensors for detecting pressure of a tip of the stylus on a surface, a printed circuit board, a power mechanism and other components. In various examples described herein a pressure sensor in the stylus for detecting pressure of a tip of the stylus on the surface, comprises a capacitive sensor, where the capacitive sensor is designed to facilitate manufacture of the stylus and remove the need for calibration of the capacitive sensor on installation in the stylus.

FIG. 1B is a cross section through part of the stylus 100 of FIG. 1A and omitting the housing of the stylus 100. The stylus 100 contains a shaft 108 that runs along a longitudinal axis of the stylus 100 interior and has a stylus tip at one end protruding from a housing of the stylus (see FIG. 1A). When the stylus 100 is used, a user holds the stylus 100 in his or her hand, as if using a conventional pen or pencil, and presses the stylus tip against a surface such as a tablet computer screen or other surface. A pressure sensor in the stylus 100 is able to detect the pressure on the shaft 108. In the case of FIG. 1B, the pressure sensor comprises a body 116 formed from conductive deformable material and a support structure 118 comprising, in this example, two legs. The legs extend beyond the body 116 and are fixable to a surface 120 in the stylus 100. The surface 120 comprises a printed circuit board with a sensing region. The sensing region comprises a conductive trace in the footprint of the body 116, and/or a MEMS sensor in the footprint of the body 116.

The support structure 118 is fixed to the surface 120 such as by fixing feet of legs to the surface 120. There is an air gap between the body 116 and the sensing region of the printed circuit board, due to the size and position of the support structure, when the capacitive sensor is in a rest state. In the rest state, the user is not operating the stylus to exert pressure on the stylus tip 102. In the rest state the shaft 108 is biased towards the stylus tip 102 by a biasing mechanism in the stylus. In the example of FIG. 1B the biasing mechanism comprises a coil spring 112, but other biasing mechanisms may be used in some other examples. When pressure is exerted on the stylus tip 102, the shaft 108 presses on body 116, the support structure flexes, and the body 116 moves into contact with the conductive trace or MEMS sensor on the surface 120. The capacitive sensor is referred to as being in an active state when the body 116 is in contact with the sensing region such as the conductive trace or MEMS sensor.

The stylus contains moving components since the shaft 108 moves slightly, back and forth along its longitudinal axis, and slightly side to side as lateral forces are exerted on the tip. One or more bearing surfaces in the stylus 100 act to minimize the side to side movement and to convey the forces along the longitudinal axis of the shaft 108. The shaft 108 is held by a clamp 110 within the stylus and a metal flange 114 around the shaft provides at least one of the bearing surfaces.

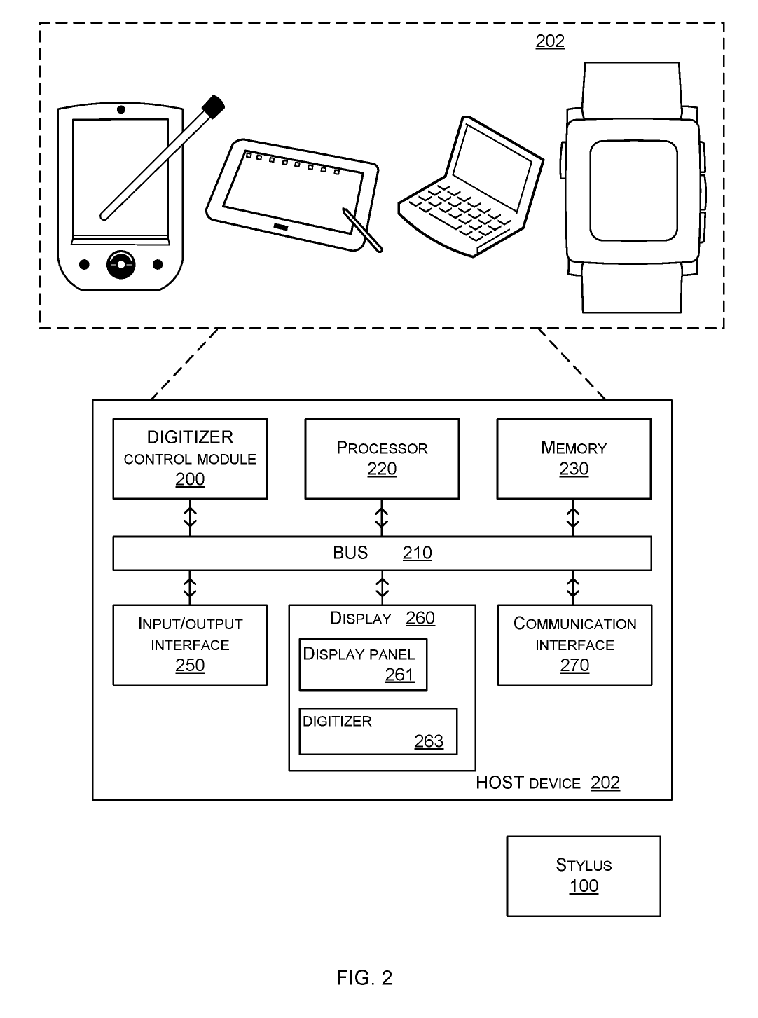

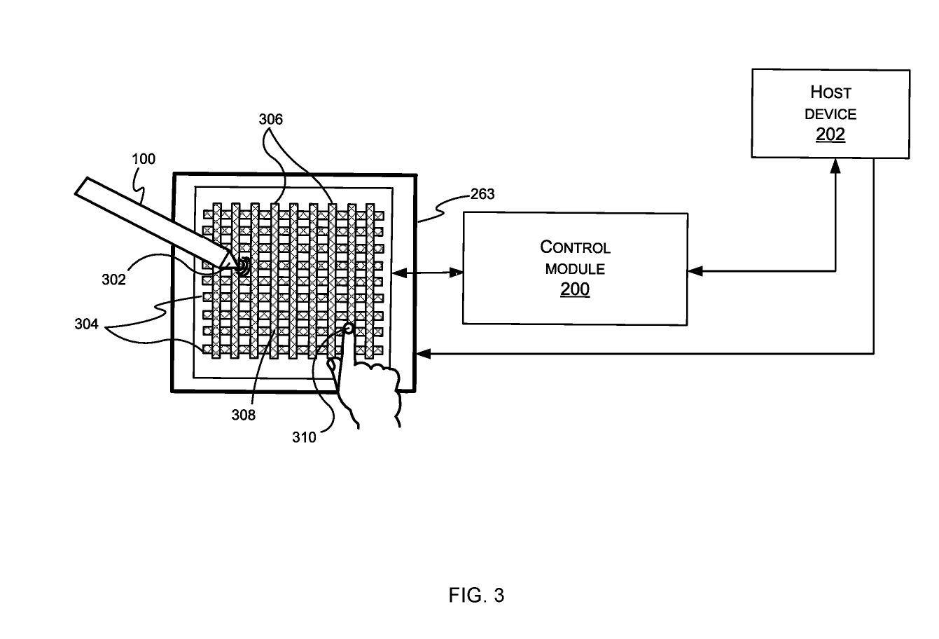

In the example of FIG. 1B, the stylus tip comprises an antenna (also referred to as an electrode) which interoperates with the digitizer as described with reference to FIGS. 2 and 3. The stylus tip antenna receives a drive signal from a printed circuit board in the stylus and the drive signal introduces an electric charge into the shaft 108. The shaft 108 is conductive and the body 116 is fixed on a distal end of the shaft 108. The body 116 is also conductive and so the charge from the shaft 108 enters the body 116. The MEMS sensor or conductive track in the footprint of the body 116 detects the charge present in the body 116 by inductance. Therefore, a low level signal is typically present at the capacitive sensor during the rest state such as when the stylus is held by a user and is hovering above an external surface rather than being in contact with an external surface. When the capacitive sensor moves into the active state the signal detected at the sensing region increases rapidly. Circuitry on the printed circuit board receives the signal detected by the sensing region and interprets the signal and/or sends the signal to another computing device.

General operation of a stylus and digitizer panel is now explained to aid understanding of the present technology. FIG. 2 is a schematic diagram of an electronic device, referred to as a host device 202 with a digitizer 263 and a digitizer control module 200. Together the digitizer 263 and the digitizer control module 200 form a digitizer device. The host device 202 may be a smart phone, tablet computer, laptop computer, smart watch or any other type of host with a digitizer 263. The host device has at least one processor 220, a memory 230, a communication interface 270 such as a radio communications transceiver, a network card, or any other communication interface for enabling wired or wireless communications with other computing entities. The host device has an input/output interface 250 for controlling outputs from the host device and for controlling inputs received at the host device 202. The host device 202, in some cases, has a display 260 although this is not essential. The display comprises a display panel 261 which may be located in front of or behind the digitizer 263 such as in a conventional smart phone, tablet computer, or smart watch. In some cases the digitizer 263 is a touch pad that is located remote from the display panel 261 as in the case of a laptop computer such as that illustrated in FIG. 2. A bus 210 connects various of the components of the host device 202 such as the digitizer control module 200, the processor 220, the memory 230, the input/output interface 250, the display 260 and the communication interface 270. In the example of FIG. 2 the digitizer 263 is shown as part of the display 260 but this is not essential as mentioned above.

The digitizer 263 comprises a first array of electrodes arranged substantially parallel with one another and a second array of electrodes arranged substantially parallel with one another. In some implementations the electrodes in the first array are row electrodes positioned substantially perpendicular to the electrodes in the second array (column electrodes) to form a grid or matrix as illustrated in FIG. 3. While the row electrodes may be referred to as transmit electrodes and the column electrodes may be referred to as receive electrodes, these designations may be reversed with no change in meaning. However, it is not essential for the electrodes to be arranged in a grid. In some cases the row electrodes intersect each column electrode an at angle that is not perpendicular thereby forming a sensor having the form of a parallelogram. In some cases the electrodes form a more complex pattern in which any two rows or columns are not necessarily parallel, or not necessarily laid out along straight lines.

Where the sensor panel is used in front of or within a display (such as a liquid crystal display) the digitizer 263 is substantially transparent to visible wavelengths of light. Specifically, the electrodes in the digitizer are made from transparent conductive material (for example, indium tin oxide), or alternatively, are made from opaque material but with traces so small as to be inconspicuous. In other implementations, the digitizer is not positioned within, in front or behind a display but rather is positioned within a touch pad distinct from the display of the electronic device.

The digitizer 263 is used to measure the capacitance from each row to each column of the electrodes in order to measure the position of an input medium such as a finger, or stylus.

FIG. 3 shows the digitizer 263 in more detail in a case where the electrodes of the digitizer are arranged in a grid to form a grid based capacitive sensor. Stylus 100 transmits an electromagnetic signal which is detected by the capacitive sensor. Touch of one or more fingers 310 or other conductive objects is also detectable by the capacitive sensor. The stylus 100 transmits one or more signal bursts and/or pulses that are transmitted at a defined repetition rate. In some examples, a control module 200 of the digitizer manages a synchronization signal for synchronizing signal bursts emitted by stylus 100 with sampling windows for sampling output from the digitizer 263. Optionally one or more signal bursts and/or pulses are transmitted by stylus 100 including information regarding operation of stylus 100 and/or pressure applied on a tip 302 of the stylus. The signal bursts transmitted by stylus 100 are picked up by one or more of the electrodes of the digitizer 263 on both the horizontal and vertical axes of the grid. In some examples the information is decoded by digitizer circuitry in the control module 200. The location of the stylus tip is computed by the control module 200 and sent to host device 202 which is a computing device with which the digitizer is associated.

Optionally a mutual capacitance detection method and/or a self-capacitance detection method are applied on the digitizer 263 for sensing interaction with fingertip 310. The digitizer control module 200 sends a triggering pulse and/or interrogation signal to one or more electrodes 304, 306 of the digitizer and to sample output from electrodes 304, 306 in response to the triggering and/or interrogation. In some embodiments some or all of the electrodes 304 along one axis of the grid are interrogated simultaneously or in a consecutive manner, and in response to each interrogation, outputs from electrodes 306 on the other axis are sampled. This scanning procedure provides for obtaining output associated with each junction 308 of the grid. The output from each junction of the grid provides for detecting one or more conductive objects such as fingertips touching and/or hovering over the digitizer at the same time (multi touch). In some examples, the digitizer control module 200 alternates between scanning the digitizer 263 for detection of one or more fingertips and sampling outputs on both the horizontal and vertical electrodes for location of a signal transmitted by the stylus 100.

The stylus 100 has a tip transmitter located in its tip 102 and the digitizer is able to detect the position of the stylus tip with respect to the digitizer grid by detecting the signal transmitted by the tip transmitter.

In various examples, the stylus has a tilt transmitter. The digitizer is able to detect tilt of the stylus 100 with respect to the plane of the digitizer 263 where the stylus 100 has a tilt transmitter in addition to a transmitter at the tip 302 of the stylus. The stylus contains a transmitter at its tip which transmits a first signal and it contains a second transmitter (referred to as a tilt transmitter) at a tilt point of the transmitter which transmits a second signal, different from the first signal. The control module 200 computes the location on the digitizer 263 of the tip 302 of the stylus 100 using the first signal. The control module 200 computes the location on the digitizer 263 of the signal received from the tilt point of the stylus 100 using the second signal. The control module 200 knows the length of the stylus 100 and is thus able to compute by triangulation the angle between the longitudinal axis of the stylus 100 and the plane of the digitizer 263.

In various examples the stylus has a plurality of transmitters configured to enable the digitizer 263 and control module 200 to detect rotation of the stylus 100.

The digitizer is able to detect position of a distal end of the stylus 100 where the stylus has at least one transmitter at its distal end. Where the distal end of the stylus 100 is used as an eraser the distal end transmitter is referred to as an eraser transmitter.

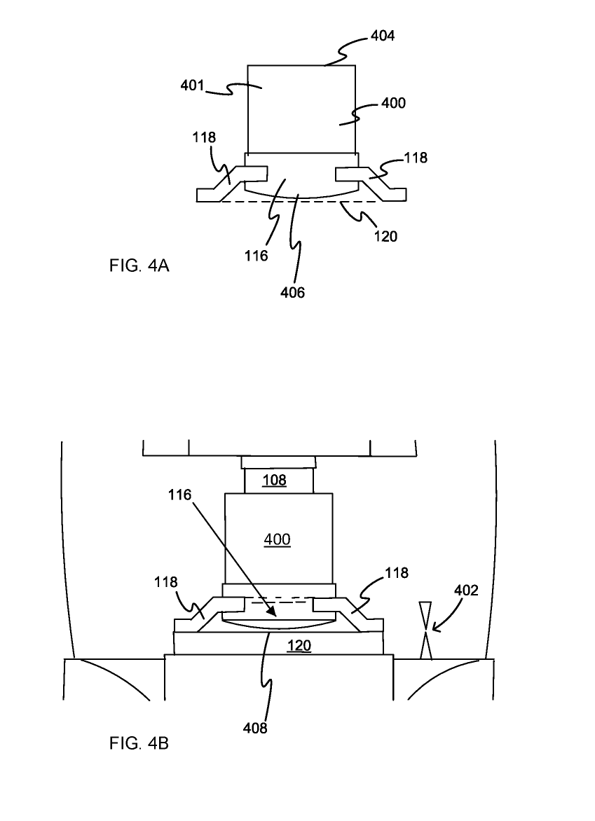

FIG. 4A is a side view of the capacitive sensor 401, before assembly inside a stylus. The capacitive sensor 401 comprises a body 400 of deformable, conductive material such as conductive silicone or other deformable conductive material. The body has a first end 404 and a second end 406. There is a face on the second end 406 of the body 400 and there is a support structure 118 extending from the body 400 of flexible conductive material beyond the second end 406 of the body 400. In some examples the body is cylindrical, or elongate and has a regular or irregular three dimensional shape.

The first end 404 of the body 400 is configured for fixing to a distal end of the shaft 108 running in the body of the stylus 100 on a longitudinal axis of the stylus 100 and having the stylus tip 102 at a tip end of the shaft 108. The second end 406 of the body 400 has a face configured to abut a sensing region of a printed circuit board of the stylus when the capacitive sensor 401 is in an active state. In an example the face of the second end 406 of the body 400 is convex as this facilitates contact of the face with the sensing region in the active state.

The support structure 118 extends from the body 400 of flexible conductive material beyond the second end 406 of the body 400. The support structure 118 is configured to be fixed to the printed circuit board such that the face of the second end 406 of the body 400 is separated from the sensing region of the printed circuit board by an air gap when the capacitive sensor 401 is in a rest state.

The support structure 118 comprises two legs in the example of FIG. 4A. The legs are of the same size and shape in the example of FIG. 4A because this makes the design symmetric for ease of assembly into the stylus, but is not essential. The support structure comprises three or more legs in some examples. In some examples, the support structure comprises a collar around the body 400 where the collar is flared towards the second end 406. The support structure is made of deformable or flexible material or webbing and in some examples is integral with the body 400 so that the body and support structure are together one single piece made of conductive deformable material.

In the example of FIG. 4A each leg comprises a first section extending generally perpendicular to the body, a second section extending from the first section at an angle towards the second end and a third section (also referred to as a foot) extending from the second section generally perpendicular to the body 400.

FIG. 4B shows the capacitive sensor inside a stylus. The body 400 of the capacitive sensor is fixed to the distal end of a shaft 108 in the stylus. The body 400 is fixed to the distal end of the shaft 108 using adhesive or in any other suitable manner. In an example, the body 400 has a recess in the first end 404 and the shaft 108 is press fit into the recess. The recess and press fit provides a particularly simple, cost effective method of assembling the capacitive sensor onto the shaft 108 of the stylus 100.

The support structure is fixed to a surface 120 in the stylus such as a surface of a printed circuit board. The printed circuit board has a sensing region 408, such as, a conductive trace, in the footprint of the body 400 although this is not visible in FIG. 4B. An air gap 402 is present between the face of the second end 406 of the body 400 and the sensing region. The pair of triangles spaced by air gap 402 are intended to indicate the air gap and are not components of the stylus or capacitive sensor.

In an example where a MEMS sensor is used in the footprint of the body 400, the air gap 402 is between the face of the second end 406 of the body 400 and the MEMS sensor.

The capacitive sensor 401 is modular and can be used in different styli where these have a shaft 108 and a surface 120 onto which the support structure can be fixed. There is no need to calibrate the capacitive sensor 401 once it has been installed inside a stylus. This is because the capacitive sensor 401 is constructed as a modular unit and the support structure extends a known amount beyond the face of the second end 406 of the body 400 such that the size of the air gap is known when the capacitive sensor is installed against a planar surface 120.

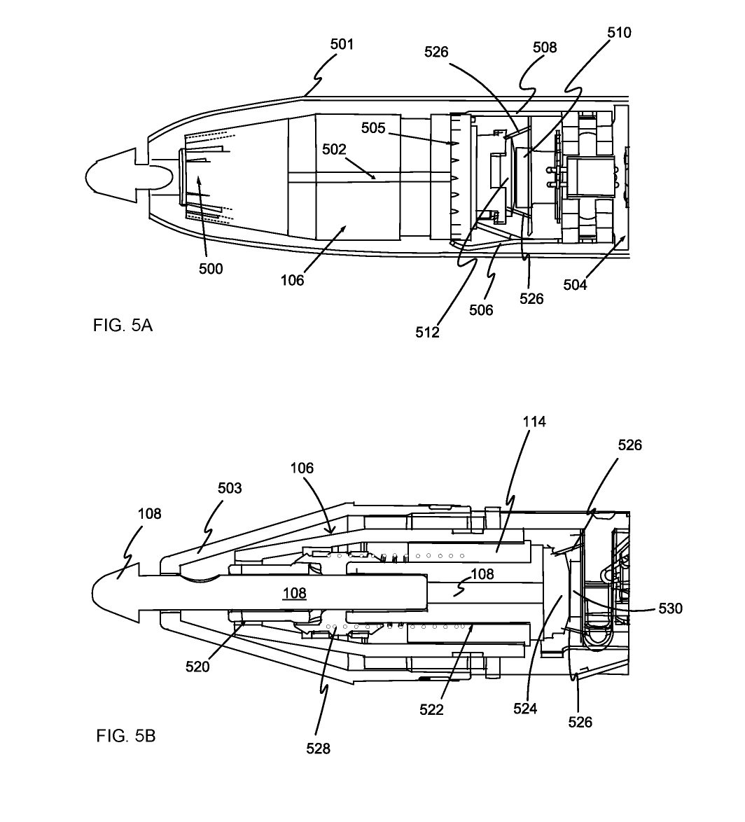

FIG. 5A is a cross section through another stylus that incorporates the capacitive sensor. In this example, the body 512 of the capacitive sensor is visible and the support structure 526 is visible. A MEMS sensor 510 is located in the footprint of the body 512 and the MEMS sensor is connected to a printed circuit board 504 in the stylus. The capacitive sensor is shown in the active state where the body 512 contacts the MEMS sensor 510.

In the example of FIG. 5A the stylus has a housing 501 with a capsule 106 of components inside it. The capsule 106 comprises an antenna 500 (such as a tilt antenna or other antenna) printed on the outside of the tapered part of the capsule housing and a metallic track 502 running from the antenna 500 to a metallic region 505 at the distal end of the capsule housing. The distal end of the capsule 106 supports the body 512 of the capacitive sensor which abuts a MEMS sensor 510 in the stylus. The printed circuit board 504 is connected to the capsule 106 using spring contacts 508, 506 which are metallic. The spring contacts enable movement of the capsule 106 along its longitudinal axis to be accommodated as pressure is put on the stylus tip in use.

FIG. 5B shows another example of components inside a stylus and with a capacitive sensor. The capacitive sensor body 524 is shown on the distal end of shaft 108 in an active state abutting a conductive trace 530 in the footprint of the body 524. The support structure 526 is shown. The stylus has a shaft 108 with a stylus tip at one end and a tip shield 503. The housing of the stylus itself is omitted in FIG. 5B for clarity. The shaft 108 bears against bearing surfaces 520, 522 on the interior of the stylus to minimize motion of the shaft 108 in a direction perpendicular to the longitudinal axis of the shaft. A coil spring 528 around the shaft 108 biases the shaft towards the tip of the stylus. A metal flange 114 holds a structure around a distal end of the shaft 108.

In the example of FIGS. 5A and 5B, the stylus tip incorporates a tip antenna. In the example of FIG. 5A signals to drive the tip antenna pass from the printed circuit board 504 through spring contact 506 to metallic flange 114 (see FIG. 1B) to spring 112 (see FIG. 1B) to bearing surface 520 (see FIG. 5B) and to the stylus tip. Signals to drive antenna 500 (see FIG. 5A) pass from the printed circuit board 504 through spring contact 508 (see FIG. 5A) to metallic region 505 to track 502 and to antenna 500.

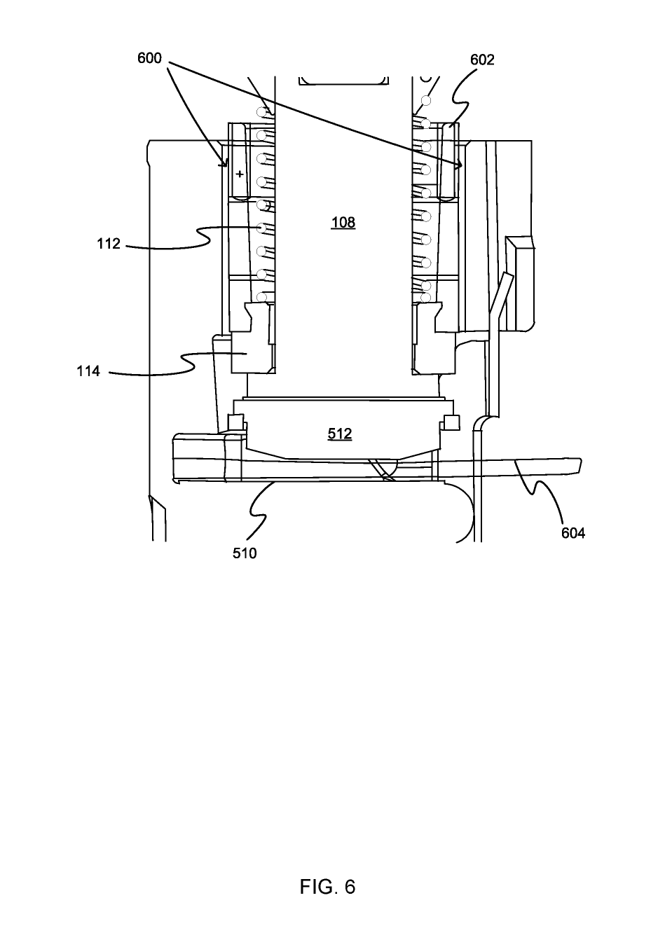

FIG. 6 is a cross section through part of a stylus during a calibration process used in previous approaches. During the calibration process components of the stylus are assembled using a shim 604 in order to reach the correct air gap. Once the components are fixed in place the shim 604 is removed.

The shaft 108 of the stylus is visible with a coil spring 112 around it. The coil spring is held in compression by a metallic flange 114 around the shaft 108 and so the shaft 108 is biased towards the tip of the stylus when the stylus is in a rest state. Adhesive 600 is present on an inner surface of a housing around the shaft 108. A piston 602 around the shaft is pressed towards the distal end of the shaft during the assembly process until the body 512 of the capacitive sensor on the distal end of the shaft 108 stops against the shim 604. The adhesive then sets, after time and/or application of heat or other radiation, and the shim 604 and piston 602 are removed. This process takes time and the use of the shim 604 and adhesive 600 is problematic.

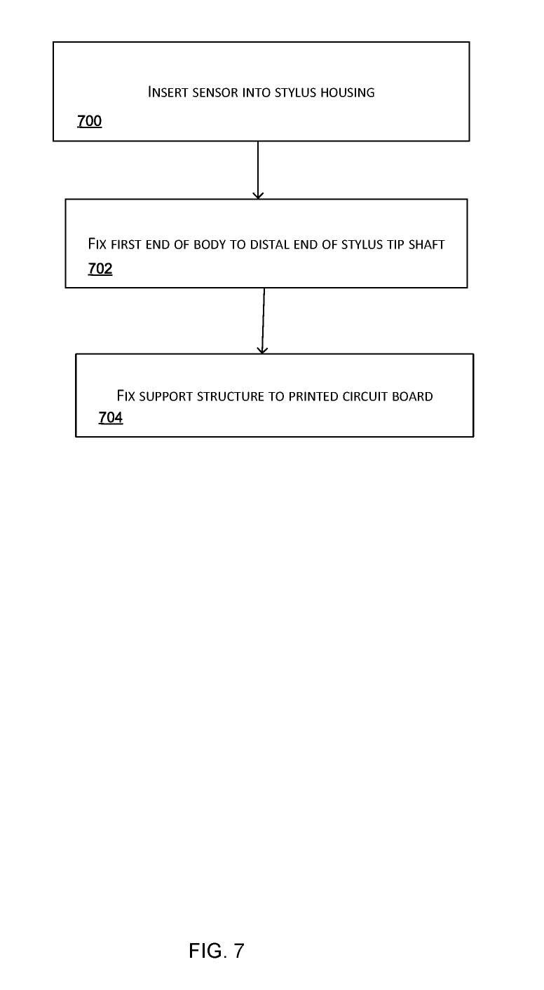

The present technology avoids the need for the complex and error prone assembly process of FIG. 6. With reference to FIG. 7 (and also using the reference numerals from FIG. 4A and FIG. 4B) a method of assembling a stylus is described using a capacitive sensor such as that described with reference to FIG. 4A and FIG. 4B. The capacitive sensor is inserted 700 into the stylus housing and a first end 404 of the body 400 is fixed 702 to a distal end of the stylus tip shaft 108. The fixing is done using any one or more of: adhesive, press fit into a recess of the body, press fit into a recess of the shaft 108, or other methods. The support structure 118 of the capacitive sensor is fixed 704 to a surface in the stylus such as a printed circuit board or other surface which supports a conductive trace or MEMS sensor in a footprint of the body 400. The fixing 704 is done using adhesive, using connection pins or in any other way. The order of operations 702 and 704 may be reversed in some examples. In some examples, the operations 702 and 704 may be carried out before encapsulation of the stylus internal components within the stylus housing.

Alternatively or in addition to the other examples described herein, examples include any combination of the following:

A capacitive sensor for use in a stylus the capacitive sensor comprising:

a body of deformable conductive material with a first end and a second end, the first end being configured for fixing to a distal end of a shaft running on a longitudinal axis of the stylus and having a stylus tip at a tip end of the shaft;

the second end of the body having a face configured to abut a sensing region on a printed circuit board of the stylus when the capacitive sensor is in an active state;

a support structure extending from the body beyond the second end of the body and configured to fix to the printed circuit board such that the face of the second end of the body is separated from the sensing region by an air gap when the capacitive sensor is in a rest state.

The capacitive sensor described above wherein the body and support structure are a one piece construction made of deformable conductive material.

The capacitive sensor described above wherein the face of the second end of the body is convex.

The capacitive sensor described above wherein the support structure comprises at least two legs which are the same size and shape as one another.

The capacitive sensor described above wherein each leg comprises a first section extending generally perpendicular to the body, a second section extending from the first section at an angle towards the second end and a third section extending from the second section generally perpendicular to the body.

The capacitive sensor described above wherein the support structure comprises a collar around the second end of the body.

The capacitive sensor described above wherein the first end of the body comprises a recess configured to press fit against the shaft.

The capacitive sensor described above wherein the body and support structure are a one piece construction made of conductive silicone.

A stylus comprising:

a shaft in a housing of the stylus, the shaft running on a longitudinal axis of the stylus and having a stylus tip at one end and a distal end;

a printed circuit board in the housing, the printed circuit board configured to generate a drive signal to drive a transmitter in the stylus tip for interoperation with a digitizer panel in use;

a capacitive sensor comprising:
a body of deformable conductive material with a first end and a second end, the first end being configured for fixing to a distal end of the shaft; the second end of the body having a face configured to abut a sensing region of the printed circuit board when the capacitive sensor is in an active state;
a support structure extending from the body of flexible conductive material beyond the second end of the body and connected to the printed circuit board such that the face of the second end of the body is separated from the sensing region by an air gap of known size when the capacitive sensor is in a rest state.

The stylus described above wherein the sensing region comprises a conductive trace opposite the second end of the body, the conductive trace configured to contact the second end of the body when the capacitive sensor is in the active state.

The stylus described above wherein the sensing region comprises a micro-electro-mechanical pressure sensor opposite the second end of the body and configured to contact the second end of the body when the capacitive sensor is in the active state.

The stylus described above wherein the body and support structure are a one piece construction made of deformable conductive material.

The stylus described above wherein the face of the second end of the body is convex.

The stylus described above wherein the support structure comprises at least two legs which are the same size and shape as one another.

The stylus described above wherein each leg comprises a first section extending generally perpendicular to the body, a second section extending from the first section at an angle towards the second end and a third section extending from the second section generally perpendicular to the body.

The stylus described above wherein the support structure comprises a collar around the second end of the body.

The stylus described above wherein the first end of the body comprises a recess configured to press fit against the shaft.

A method of manufacturing a stylus, the method comprising:

inserting a one piece construction of deformable conductive material into a stylus housing the one piece construction of deformable conductive material having:

a body with a first end and a second end, a face on the second end of the body;

a support structure extending from the body of flexible conductive material beyond the second end of the body;

fixing the first end of the body to a distal end of a stylus tip shaft running in the body of the stylus;
fixing the support structure to a printed circuit board in the stylus such that there is an air gap of specified size between the face on the second end of the body and a sensing region of the printed circuit board when the one piece construction of deformable conductive material is in a rest state.

The method of manufacturing described above comprising fixing the first end of the body to the distal end of the stylus tip shaft by press-fitting the distal end of the stylus tip shaft into a recess in the first end of the body.

The method of manufacturing described above comprising fixing the support structure to the printed circuit board by fixing feet of legs of the support structure to the printed circuit board.

The term ‘computer’ or ‘computing-based device’ is used herein to refer to any device with processing capability such that it executes instructions. Those skilled in the art will realize that such processing capabilities are incorporated into many different devices and therefore the terms ‘computer’ and ‘computing-based device’ each include personal computers (PCs), servers, mobile telephones (including smart phones), tablet computers, set-top boxes, media players, games consoles, personal digital assistants, wearable computers, and many other devices.

The methods described herein are performed, in some examples, by software in machine readable form on a tangible storage medium e.g. in the form of a computer program comprising computer program code means adapted to perform all the operations of one or more of the methods described herein when the program is run on a computer and where the computer program may be embodied on a computer readable medium. The software is suitable for execution on a parallel processor or a serial processor such that the method operations may be carried out in any suitable order, or simultaneously.

This acknowledges that software is a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions are optionally distributed across a network. For example, a remote computer is able to store an example of the process described as software. A local or terminal computer is able to access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The operations of the methods described herein may be carried out in any suitable order, or simultaneously where appropriate. Additionally, individual blocks may be deleted from any of the methods without departing from the scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

The term ‘subset’ is used herein to refer to a proper subset such that a subset of a set does not comprise all the elements of the set (i.e. at least one of the elements of the set is missing from the subset).

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the scope of this specification.

1. A capacitive sensor for use in a stylus, the capacitive sensor comprising:
a body of deformable conductive material with a first end and a second end, the first end being configured for fixing to a distal end of a shaft running on a longitudinal axis of the stylus and having a stylus tip at a tip end of the shaft;
the second end of the body having a face configured to abut a sensing region on a printed circuit board of the stylus when the capacitive sensor is in an active state; and
a support structure extending from the body beyond the second end of the body and configured to fix to the printed circuit board such that the face of the second end of the body is separated from the sensing region by an air gap when the capacitive sensor is in a rest state.

2. The capacitive sensor of claim 1 wherein the body and support structure are a one piece construction made of deformable conductive material.

3. The capacitive sensor of claim 1 wherein the face of the second end of the body is convex.

4. The capacitive sensor of claim 1 wherein the support structure comprises at least two legs which are the same size and shape as one another.

5. The capacitive sensor of claim 4 wherein each leg comprises a first section extending generally perpendicular to the body, a second section extending from the first section at an angle towards the second end and a third section extending from the second section generally perpendicular to the body.

6. The capacitive sensor of claim 1 wherein the support structure comprises a collar around the second end of the body.

7. The capacitive sensor of claim 1 wherein the first end of the body comprises a recess configured to press fit against the shaft.

8. The capacitive sensor of claim 1 wherein the body and support structure are a one piece construction made of conductive silicone.

9. A stylus comprising:
a shaft in a housing of the stylus, the shaft running on a longitudinal axis of the stylus and having a stylus tip at one end and a distal end;
a printed circuit board in the housing, the printed circuit board configured to generate a drive signal to drive a transmitter in the stylus tip for interoperation with a digitizer panel in use; and
a capacitive sensor comprising:
a body of deformable conductive material with a first end and a second end, the first end being configured for fixing to a distal end of the shaft; the second end of the body having a face configured to abut a sensing region of the printed circuit board when the capacitive sensor is in an active state;
a support structure extending from the body beyond the second end of the body and connected to the printed circuit board such that the face of the second end of the body is separated from the sensing region by an air gap of known size when the capacitive sensor is in a rest state.

10. The stylus of claim 9 wherein the sensing region comprises a conductive trace opposite the second end of the body, the conductive trace configured to contact the second end of the body when the capacitive sensor is in the active state.

11. The stylus of claim 9 wherein the sensing region comprises a micro-electro-mechanical pressure sensor opposite the second end of the body and configured to contact the second end of the body when the capacitive sensor is in the active state.

12. The stylus of claim 9 wherein the body and support structure are a one piece construction made of deformable conductive material.

13. The stylus of claim 9 wherein the face of the second end of the body is convex.

14. The stylus of claim 9 wherein the support structure comprises at least two legs which are the same size and shape as one another.

15. The stylus of claim 14 wherein each leg comprises a first section extending generally perpendicular to the body, a second section extending from the first section at an angle towards the second end and a third section extending from the second section generally perpendicular to the body.

16. The stylus of claim 9 wherein the support structure comprises a collar around the second end of the body.

17. The stylus of claim 9 wherein the first end of the body comprises a recess configured to press fit against the shaft.

18. A method of manufacturing a stylus, the method comprising:
inserting a one piece construction of deformable conductive material into a stylus housing, the one piece construction of deformable conductive material having:
a body with a first end and a second end,
a face on the second end of the body;
a support structure extending from the body beyond the second end of the body;
fixing the first end of the body to a distal end of a stylus tip shaft running in the body of the stylus;
fixing the support structure to a printed circuit board in the stylus such that there is an air gap of specified size between the face on the second end of the body and a sensing region of the printed circuit board when the one piece construction of deformable conductive material is in a rest state.

19. The method of claim 18 comprising fixing the first end of the body to the distal end of the stylus tip shaft by press-fitting the distal end of the stylus tip shaft into a recess in the first end of the body.

20. The method of claim 18 comprising fixing the support structure to the printed circuit board by fixing feet of legs of the support structure to the printed circuit board.
